(19) United States
(12) Patent Application Publication
(10) Pub. No.: US 2005/0034586 A1
(43) Pub. Date: Feb. 17, 2005

(54) Adjustable drill bushing alignment device

(75) Inventors: James Wesley Trisler JR., Gainesville, TX (US); Ben Stuart Lyson, Denton, TX (US); Kathy Ellen Needleman, Dallas, TX (US)

Correspondence Address: SIDLEY AUSTIN BROWN & WOOD LLP, 717 NORTH HARWOOD, SUITE 3400, DALLAS, TX, 75201, US

(73) Assignee: PACCAR INC

(21) Appl. No.: 10/641,557

(22) Filed: Aug. 15, 2003

(51) Int. Cl. B26D 1/00

(52) U.S. Cl. 83/651; 83/13

(57) ABSTRACT

A drill bushing alignment assembly attachable to a fixture and a method for repositioning a drill bushing with respect to the fixture. The drill bushing alignment assembly has a body defining a body hole having a body hole diameter; a bushing having a bushing diameter and defining a bushing hole; a plurality of positioners for securing the bushing within the body hole such that a position of the bushing within the body hole is adjustable; and a plurality of removable fasteners for detachably securing the body to the fixture through substantially equidistant holes defined correspondingly in both the fixture and the body. The holes are preferably patterned such that the holes in the fixture and body align even when the body is rotated relative to the fixture. The body hole may be offset from a center of the body to provide a greater range of adjustment of the drill bushing position.

### FIELD OF THE INVENTION

This invention relates to a drill bushing alignment device. More specifically, the invention relates to an apparatus and method of using the apparatus for adjusting a location for drilling a hole in a piece by repositioning a drill bushing within a drill bushing alignment assembly.

### BACKGROUND OF THE INVENTION

Drill bushings are used to position a drill bit when it is necessary to reliably and quickly drill identically positioned and identically formed holes in large numbers of pieces which are inserted into a stabilizing fixture. A hole is drilled in the fixture, and the drill bushing is inserted therein. The drill bushing is positioned and attached to the fixture such that a center of the drill bushing installed therein aligns with a desired position of a center of a hole to be drilled in a piece which will later be inserted into the fixture. Thus, any hole drilled through the drill bushing will be uniformly positioned on all pieces inserted into the fixture. Once the bushing is found to be in tolerance, then no other positioning is done to center the hole closer to nominal.

Currently, the conventional method of positioning a drill bushing on the fixture, such as fiberglass splashes or other pieces, is done by laying out the desired location of each hole and then drilling the splash to securely accept a drill bushing. Unfortunately, with the conventional drill bushing location method, if a drill bushing is initially incorrectly positioned or if a desired hole position is changed due to design or manufacturing changes, a series of time consuming and labor intensive steps must be performed, especially if the desired position of the new drill bushing hole is to be less than a full drill bushing diameter from the current drill bushing hole. Initially, the drill bushing must be forcibly removed (punched out) from its tightly secured position within the fixture. Then, the hole in the fixture must be repaired. If the fixture is formed from fiberglass, this entails filling the fiberglass hole with epoxy filler, waiting for the filler to dry, and then sanding the repair smooth, both top and bottom. Finally, a new hole suitable for accepting the drill bushing must be drilled. If the old drill bushing holes are not filled, the securing holes through the fixture will be incorrectly sized or shaped and the drill bushing will not securely seat within the hole in the fixture. If the filled holes are not sanded smooth and leveled, the drill bushing will not sit flush with the fixture, and a hole may inadvertently be drilled in the piece at an incorrect position or at an incorrect angle. Thus, every time a conventional drill bushing is repositioned with respect to the fixture, even just a slight bit, production must stop until the drill bushing is correctly positioned within the fixture.

The process of filling, waiting for the filler to dry, sanding the filler smooth, and then redrilling a hole for receiving the drill bushing in a desired position, wastes valuable manufacturing time and costs money. Additionally, the conventional method of forming a hole for securing a drill bushing to a fixture is generally adapted for providing a hole for receiving only one size drill bushing. Therefore, every time a different size drill bushing is required (either smaller or larger), a new hole must be drilled.

What is needed is an adjustable drill bushing alignment assembly which provides for adjusting the position of the drill bushing without necessitating the filling and redrilling of the previous drill bushing hole in the fixture in order to reposition the drill bushing to a desired location.

What is also needed is an adjustable drill bushing alignment assembly which accommodates different size bushings within the alignment assembly without necessitating the filling and redrilling of the previous drill bushing hole in the fixture.

### SUMMARY OF THE INVENTION

An adjustable drill bushing alignment assembly attachable to a fixture and a method for repositioning a center of a drill bushing within the adjustable drill bushing alignment assembly from a first position to a second position relative to a fixture without necessitating the filling and redrilling of a previous drill bushing hole in the fixture in order to reposition the drill bushing are described herein.

Further, an adjustable drill bushing alignment assembly attachable to a fixture which accommodates different size bushings within the alignment assembly without necessitating the filling and redrilling of the previous drill bushing hole in the fixture is described herein.

According to a first embodiment, a drill bushing alignment assembly includes a body defining a body hole having a body hole diameter; a bushing having a bushing diameter and defining a bushing hole having a bushing hole diameter; a plurality of positioners for securing the bushing within the body hole such that a position of the bushing within the body hole is adjustable. The alignment assembly is detachably coupled to a fixture by a plurality of removable fasteners secured through a plurality of securing holes correspondingly defined in both the fixture and the body such that the securing holes in the body align with the securing holes in the fixture. Preferably, the plurality of securing holes are three holes spaced equidistant apart such that the alignment assembly can be rotated from a first orientation to a second orientation and the securing holes will align with the corresponding securing holes of the rotated alignment assembly. Preferably the plurality of positioners are a plurality of threaded pins extending through equidistant spaced correspondingly threaded passageways defined through the body. Preferably, an end of each of the plurality of threaded pins extends into the body hole in contact with the bushing, thereby adjustably securing the bushing within the body. Preferably, the plurality of securing holes of both the fixture and the body are patterned such that the plurality of securing holes in the fixture and the body realign as the body is rotated relative to the fixture.

According to a second embodiment, the body hole is offset from a center of the body. Additionally, instead of three securing holes, preferably the body defines one securing hole and two securing slots. By loosening the securing fasteners inserted through the slots securing the adjustable drill bushing alignment assembly to the fixture, the drill bushing alignment assembly can be rotated about the securing fastener in the one securing hole, thus repositioning a drill bushing inserted therein to a desired position relative to the fixture. Providing equidistant spaced holes in the body corresponding to equidistant spaced holes in the fixture reduces the number of holes which need to be drilled in the fixture when the bushing is repositioned. Providing a body hole offset from the center of the body in addition to equidistant spaced securing holes provides a greater degree of adjustment of the bushing position with respect to the fixture by allowing the assembly to be rotated, thus providing a wider range of positions for the body hole.

Additionally, according to any embodiment of the invention, the adjustable drill bushing assembly is adapted to receive any of a variety of sized or shaped drill bushings. Further, each of the plurality of drill bushings may define a different size drill hole having a different size inner diameter from the others of the plurality of drill bushings.

### BRIEF DESCRIPTION OF THE DRAWINGS

FIG. 1 is an environmental view of an exemplary first embodiment of an adjustable drill bushing alignment assembly coupled with an exemplary fixture and a drill being used to drill a hole in an exemplary piece;

FIG. 2 is a perspective view of a first embodiment of an adjustable drill bushing alignment assembly according to the present invention;

FIG. 3 is an exploded view of the first embodiment of the adjustable drill bushing alignment assembly illustrated in FIG. 2;

FIG. 4 is a perspective view of the first embodiment of the adjustable drill bushing alignment assembly illustrated in FIG. 2, with the drill bushing offset from a central position;

FIG. 5 is an exploded perspective view of the first embodiment of the adjustable drill bushing alignment assembly of FIG. 2, illustrated in relation to an exemplary fixture;

FIG. 6 is a perspective view of a second embodiment of an adjustable drill bushing alignment assembly according to the present invention;

FIG. 7 is a top view of the second embodiment of the adjustable drill bushing alignment assembly illustrated in FIG. 6, illustrating positional adjustment; and

FIG. 8 is an exploded perspective view of the second embodiment of the adjustable drill bushing alignment assembly of FIG. 6, illustrated in relation to an exemplary fixture.

### DETAILED DESCRIPTION OF THE INVENTION

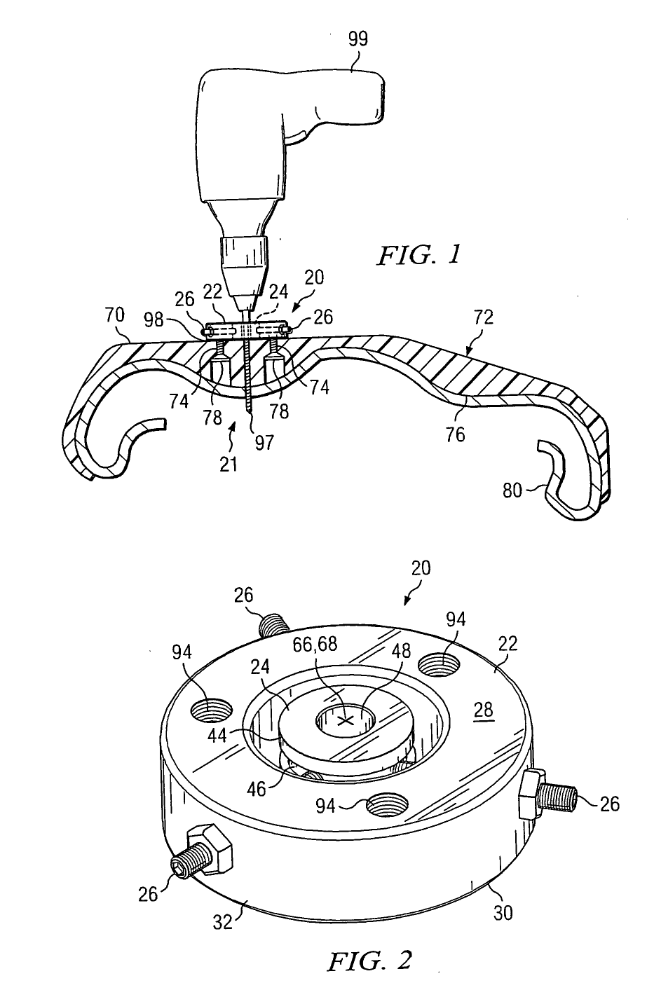

Referring to FIG. 1, a first embodiment of a drill bushing alignment assembly 20 for aligning a drill bushing 24 with a desired position 21 for drilling a hole in an exemplary piece 80 is illustrated. As shown, the drill bushing alignment assembly 20 is detachably secured to an exemplary fixture 72 such that the drill bushing 24 can be repositioned and ultimately centered at the desired position 21 for drilling. The fixture 72 functions to secure the drill bushing alignment assembly 20 and support the piece 80 during drilling such that a drill bit 97 of a drill 99 will be positioned (centered) above the desired position 21 for drilling into the piece 80.

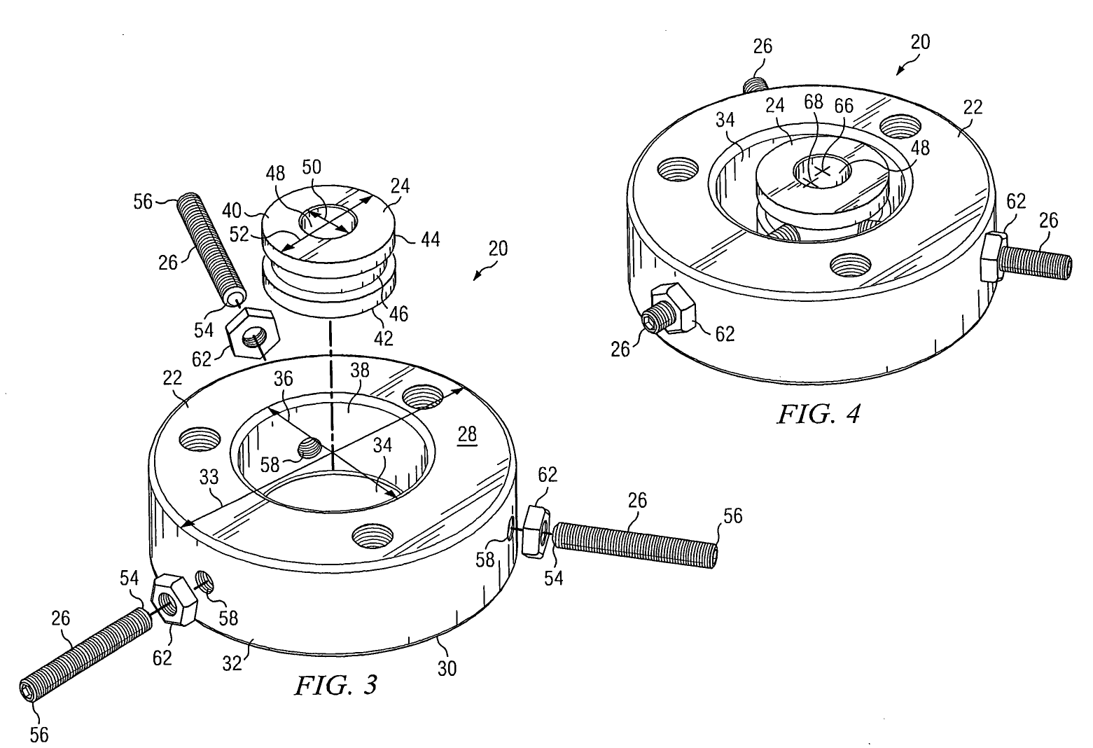

Referring now to FIGS. 1, 2, and 3, a first embodiment of a drill bushing alignment assembly 20 includes: a body 22; a drill bushing 24; and a plurality of positioners 26. The body 22 has a first side 28 and a second side 30 with an outer peripheral side 32 therebetween. The body 22 has a body diameter 33. Preferably, the first and second sides 28, 30 of the body 22 are substantially flat and substantially parallel to one another. A drill bushing positioning hole 34 having a diameter 36 less than the body diameter 33 is defined through the first and second sides 28, 30 thereby forming an inner peripheral side 38 of the body 22. The drill bushing 24 also has a first side 40 and a second side 42, with an outer peripheral side 44 therebetween. Preferably, the first and second sides 40, 42 of the drill bushing 24 are substantially flat and substantially parallel with one another. The outer peripheral side 44 of the drill bushing 24 preferably defines a channel 46 at least partially therealong. The drill bushing 24 defines a drill bit positioning hole 48 having a diameter 50 adapted to receive a drill bit. The drill bushing 24 has an outer diameter 52 smaller than the diameter 36 of the drill bushing positioning hole 34 in the body 22. The plurality of positioners 26 are preferably threaded rods each having a first end 54 and a second end 56. The plurality of positioners 26 are preferably adapted to be received into a corresponding plurality of correspondingly threaded holes 58 defined through the body 22 from the outer peripheral side 32 to the inner peripheral side 38. Preferably, the corresponding plurality of threaded holes 58 are disposed at points spaced substantially equidistant apart along the body 22 such that the plurality of positioners 26 threaded therethrough would be spaced substantially equidistant apart. Preferably, the plurality of positioners 26 have a length such that the first ends 54 of the plurality of positioners 26 extend into the drill bushing positioning hole 34, and the second ends 56 of the plurality of positioners 26 extend beyond the outer peripheral side 32 of the body 22.

The drill bushing 24 is adjustably yet securely retained within the bushing positioning hole 34 of the body 22 by the plurality of equidistantly spaced positioners 26. The drill bushing 24 is positioned such that a center 66 of the drill bit positioning hole 48 is positioned in the desired position. The plurality of positioners 26 are adjusted until their respective first ends 54 make contact with the channel 46 of the drill bushing 24. The channel 46 is adapted to receive and be secured in a desired position by the first ends 54 of each of the plurality of positioners 26. Thus, the drill bushing 24 is secured in the body 22 such that the center 66 of the drill bit positioning hole 48 remains centered at the desired position. Preferably, a correspondingly threaded locking nut 62 or other releasable securing means is threaded onto the extending second end 56 of each of the threaded positioners 26 thereby locking the plurality of positioners 26 a desired distance into the bushing positioning hole 34, and thus preventing the plurality of positioners 26 from rotating in the corresponding threaded holes 58.

FIG. 2 illustrates the first embodiment of the drill bushing alignment assembly 20 where a center 66 of the drill bit positioning hole 48 of the drill bushing 24 substantially aligns with a center 68 of the drill bushing positioning hole 34 of the body 22. Alternately, FIG. 4 illustrates the first embodiment of the drill bushing alignment assembly 20 with the center 66 of the drill bit positioning hole 48 of the drill bushing 24 shifted in position from the center 68 of the drill bushing positioning hole 34 of the body 22 such that the two centers 66, 68 do not align. According to FIG. 4, the drill bushing 24 is adjusted positionally such that each of the plurality of positioners 26 extends a different length into the drill bushing positioning hole 34, while the first ends 54 of the plurality of positioners 26 still maintain contact with the channel 46 of the drill bushing 24. This is accomplished by rotating the plurality of threaded positioners 26 in and out of the correspondingly threaded holes 58 until the center 66 of the drill bit positioning hole 48 of the drill bushing 24 is positioned at a desired position. Once the drill bushing 24 has been properly aligned, the plurality of positioners 26 can be adjusted to secure the drill bushing 24 in the desired position. The removable locking nut 62 or other removable stop is then inserted onto and tightened about the second ends 56 of each of the threaded plurality of positioners 26 to prevent them from moving or rotating within their respective threaded hole 58. Thus, the drill bushing 24 is maintained in the new, off center position.

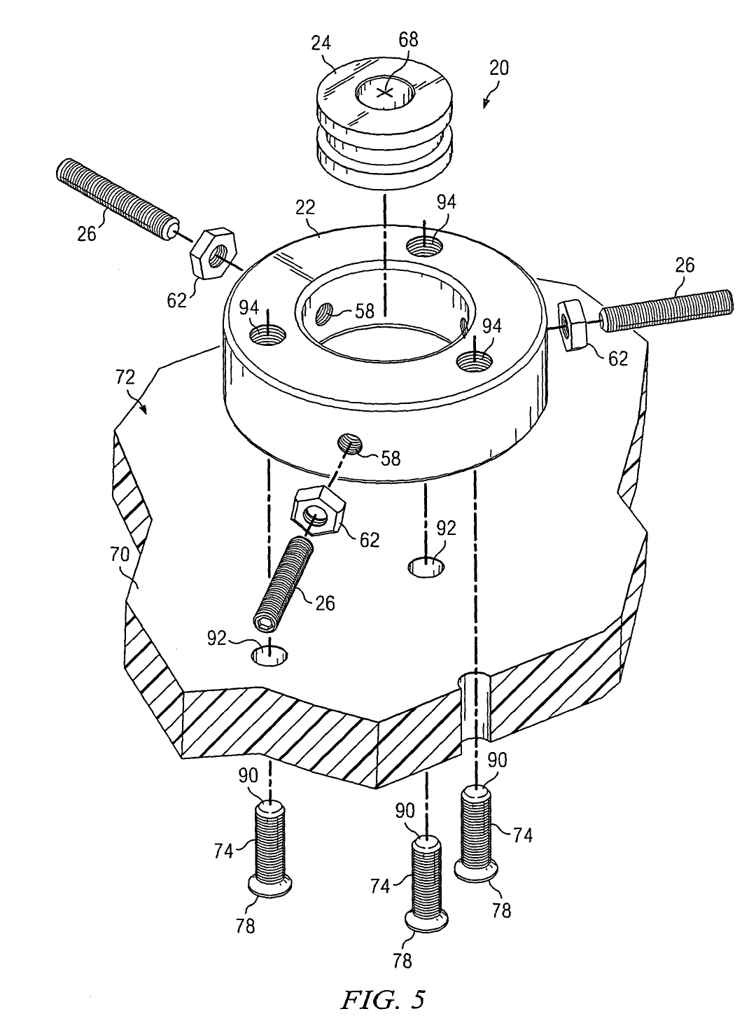

Referring now to FIGS. 1, 2, and 5, the body 22 of the drill bushing alignment assembly 20 is adapted to be attached to an exterior surface 70 of a fixture 72 by a plurality of threaded securing screws 74 secured through a corresponding plurality of threaded securing holes 92 defined through an inside surface 76 of the fixture 72 into a corresponding plurality of correspondingly positioned threaded securing holes 94 in the body 22. The securing screws 74 are preferably countersunk such that heads 78 of the securing screws 74 do not interfere with the placement of a piece 80 along the inside surface 76 of the fixture 72. A length of the securing screws 74 is preferably predetermined based on a thickness of the fixture 72 at the desired drilling location 21 or position of attachment and a thickness of the body 22 of the drill bushing alignment assembly 20 such that ends 90 of the securing screws 74 do not extend outwardly beyond the threaded securing holes 94 in the body 22. Preferably, the corresponding plurality of correspondingly positioned securing holes 92, 94 (fixture and body respectively) are spaced substantially equidistant apart such that the drill bushing alignment assembly 20 can be rotated for a greater range of repositioning of the center 68 of the drill bushing 24 relative to the fixture 72 without having to unscrew the plurality of threaded positioners 26 and locking nuts 62, reposition the drill bushing 24, and then reposition and secure the plurality of threaded positioners 26 with the drill bushing 24 properly centered.

FIG. 1 further illustrates the first embodiment of the drill bushing alignment assembly 20 coupled to an exemplary fixture 72. A drill having a drill bit is being used to drill a hole in an exemplary piece 80 positioned in the exemplary fixture 72. Since the piece 80 could have any shape, size, thickness or contour, preferably, the inside surface 76 of the fixture 72 is adapted to substantially conform to a shape of the piece to be drilled such that the piece is supported in a desired position and orientation. Preferably, the exterior surface 70 of the fixture 72 is formed substantially flat to receive the adjustable drill bushing assembly 20, especially in an area 98 surrounding a desired position 21 of a hole to be drilled. Preferably, like pieces can be interchangeably inserted onto the fixture and a hole drilled reliably in a same desired position on each of the interchangeable pieces. Preferably, the fixture is securable to a table or drilling bench or other stable surface (not illustrated) so that the fixture 72, piece 80, and drill 99 are easily stabilized during drilling. Thus, when using the drill bushing alignment assembly 20 of the present invention along with a fixture or support adapted to maintain a piece stably in a desired position for drilling, a hole can be reliably drilled in a desired position in a piece having any shape, size, thickness, or have any degree of curvature.

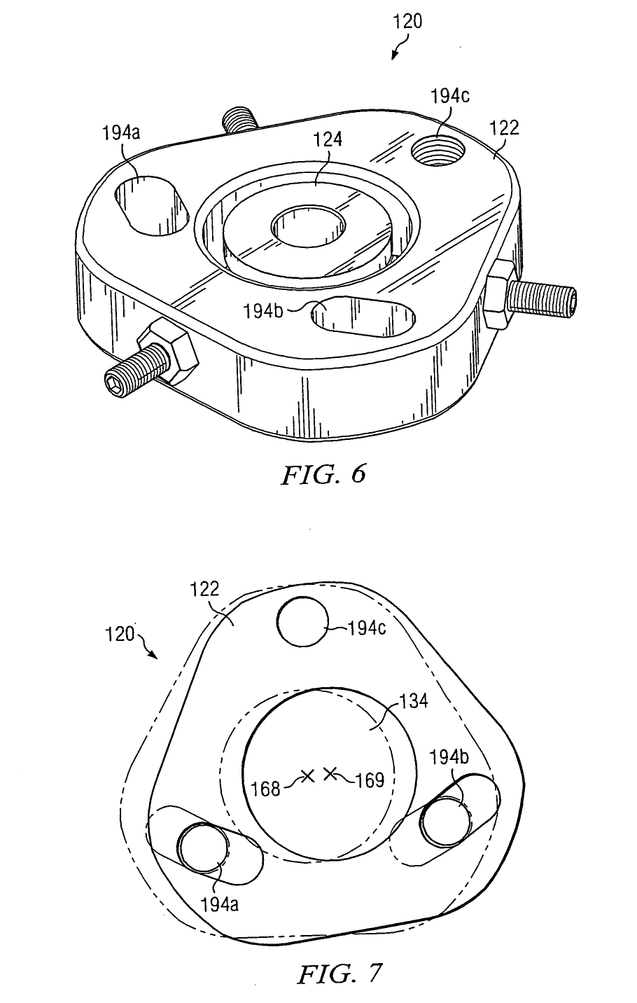

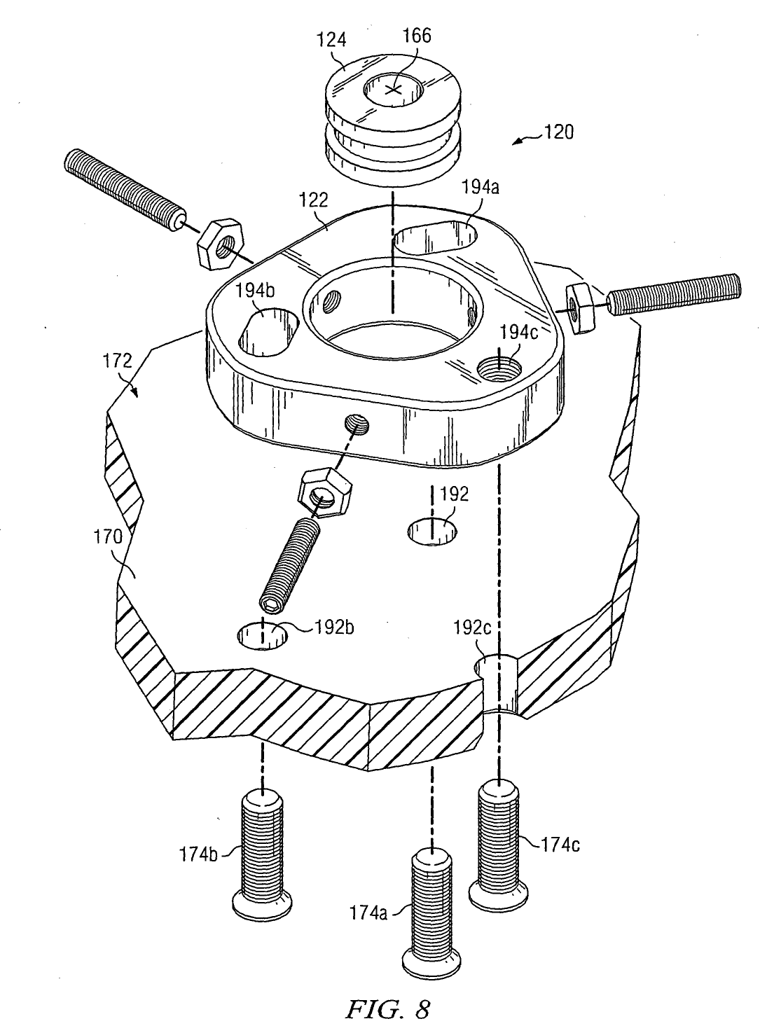

FIGS. 6, 7, and 8 illustrate a second embodiment of a drill bushing alignment assembly 120 of the present invention. For clarity, like parts are numbered similarly incremented by 100. According to the second embodiment of the drill bushing alignment assembly 120 illustrated in FIG. 6, the body 122 is shaped substantially as a triangle for easier handling. Preferably, the corresponding plurality of correspondingly positioned securing holes 192, 194 (fixture and body respectively) are three equidistant spaced securing holes. Preferably, the body 122 can be rotated relative to the fixture 172 and the securing holes 192, 194 (fixture and body respectively) will align in the rotated orientation. Further, as illustrated in FIG. 7, a center 168 of the drill bushing positioning hole 134 in the body 122 of the second embodiment 120 is offset from a geometric center 169 of the body 122. These modifications provide a greater range for repositioning the center 166 of the drill bushing 124 relative to the fixture 172.

Additionally, preferably, two of the three securing holes 194 in the body 22 are formed as slots 194a, 194b such that the body pivots about the one of the securing screws in the one securing hole 192c, 194c while the remaining securing screws slide within the two slots 194a, 194b of the body. The arrangement of the slots 194a, 194b is adapted such that as the body 122 is shifted, some portion of the slots 194a, 194b remain positioned over the corresponding securing holes 192a, 192b defined in the fixture 172 for receiving the securing screws 174. According to the second embodiment 120, minor adjustments in the position of the center 166 of the drill bushing 124 can be made by merely loosening the securing screws 174a, 174b secured through the securing holes in the fixture 192a, 192b and into the slots 194a, 194b and adjusting a position of the body 122 by pivoting the body 122 about one of the securing screws 174c while securing screws 174a, 174b slide within the two slots 194a, 194b. The arrangement of the slots 194a, 194b allows for additional flexibility of adjustment of the position of the drill bushing alignment assembly 120 relative to the fixture 172 and allows for minor adjustments of the center 166 of the drill bushing relative to the fixture without having to manipulate the plurality of positioners in order to reposition the drill bushing or to fully disengage the drill bushing assembly from the fixture.

It will be appreciated by those skilled in the art that the diameter of the body of the drill bushing assembly could be formed of any size such that securing holes in the body will align with corresponding securing holes drilled in the fixture. However, in order to maximize the flexibility of the assembly and allow for holes to be drilled in a relatively large area of a piece within a fixture without having to redrill securing holes in the fixture, it will be appreciated by those skilled in the art that the larger the body, and thus the larger the hole in the body, the greater is the degree of possible repositioning of a drill bushing within the body hole.

Further, it will be appreciated by those skilled in the art that a greater degree of flexibility of position of a center of a drill hole relative to a fixture could be achieved if a drill bushing having off center holes defined therein were used. While not illustrated herein, a fine adjustment of a center position of the drill hole can be achieved by positioning the drill bushing within the body of the drill bushing alignment assembly substantially at a desired position with respect to a fixture, securing the drill bushing in substantially the desired position, and then rotating the drill bushing relative to the plurality of securing positioners such that the off center drill hole is rotated into a desired alignment with a desired drill position.

Having thus described several embodiments of the invention, it is apparent that using the drill bushing alignment assembly described above allows a single technician to quickly and easily adjust a position of a drill bushing without having to drill additional securing holes in the fixture. It is recognized, however, that those skilled in the art may make various modifications or additions to the preferred embodiments chosen to illustrate the invention herein without departing from the scope or spirit of the present contribution to the art. Thus, while the exemplary embodiments of the drill bushing alignment assembly are described and illustrated herein as having a body with either a substantially circular shape or a substantially triangular shape, it will be appreciated by those skilled in the art that the body of the drill bushing alignment assembly could instead by formed in any shape, size, or configuration so long as a space for positioning and adjustably securing a drill bushing were provided. Further, while the bodies of the exemplary embodiments are illustrated and described herein as having three securing holes, it will be appreciated that any number of securing holes could instead be provided. Moreover, while it is herein illustrated that the drill bushing alignment assembly is secured to the frame by means of securing screws inserted through holes drilled in the fixture into corresponding holes in the body of the drill bushing alignment device, it will be appreciated by those skilled in the art that the alignment device could instead employ other securing means. By way of example and not by way of limitation, securing means such as but not limited to: clips, pins, expandable bands, or straps and buckles, pins, clips, tacky strips, magnets, and dissolvable adhesives may be used. Moreover, while the various embodiments having been illustrated having three positioners in a particular arrangement, it will be appreciated that any number of positioners positioned in any of a variety of arrangements could instead be employed to secure the drill bushing in the drill bushing alignment device. Moreover, while the drill bushing has been described as having a channel for receiving the plurality of positioners to thus secure the drill bushing within the drill bushing alignment assembly, it will be appreciated by those skilled in the art that the channel could be a slots, grooves, holes, or indentations formed between raised portions. Further, the drill bushing could be formed without the channel and the plurality of positioners adapted to secure the drill bushing within the drill bushing alignment assembly in some other manner such as by means of gripping feet attached at an end of each of the positioners which contact the outer surface of the drill bushing and securely hold the drill bushing therebetween. Further, the drill bushing could be adjustably secured therein by any other means now known or later developed. Further, while a particular diameter drill bushing has been illustrated, it will be appreciated by those skilled in the art that any of a variety of sizes of diameter drill bushings could instead be used. Also, while the body of the drill bushing alignment assembly has been illustrated as being a particular size in relation to the drill bushing, it will be appreciated by those skilled in the art that the body of the drill bushing alignment assembly could be of any size smaller than the fixture to which it is to be attached, and adapted to receive any desired diameter drill bushing. Thus, the scope of the invention is not limited merely thereto. Accordingly, it is to be understood that the protection sought and to be afforded hereby should be deemed to extend to the subject matter claimed and all equivalents thereof fairly within the scope of the invention.

1. A drill bushing alignment assembly, comprising:
a body defining a body cavity having a body cavity diameter and defining a plurality of securing holes for securing the body to a fixture;
a bushing defining a bushing hole therethrough, said bushing having a diameter smaller than said body cavity diameter;
a plurality of positioners for securing the bushing within the body cavity such that a position of the bushing within the bushing cavity is adjustable.

2. A drill bushing alignment assembly as claimed in claim 1, wherein the plurality of securing holes are substantially equidistant spaced.

3. A drill bushing alignment assembly as claimed in claim 1,
wherein said plurality of positioners are threaded pins,
wherein said body defines a plurality of threaded passageways therethrough adapted to receive the corresponding plurality of threaded pins such that said threaded pins extend into the body cavity.

4. A drill bushing alignment assembly as claimed in claim 1,
wherein said bushing has a bushing outer circumferential surface which defines a groove at least partially along the bushing outer circumferential surface;
and wherein an end of each of the plurality of positioners is adapted to fit within the groove.

5. A drill bushing alignment assembly as claimed in claim 1,
wherein a center of the body cavity is offset from a center of the body.

6. A drill bushing alignment assembly as claimed in claim 1,
wherein a center of the bushing hole is offset from a center of the bushing.

7. A drill bushing alignment assembly as claimed in claim 1,
wherein the body is adapted to receive any one of a variety of different diameter bushings.

8. An adjustable drill bushing alignment assembly, comprising:
a body having a first surface and a second surface and an outer circumferential surface therebetween, said body defining a body hole having a body hole diameter through said first and second surfaces thereby forming an inner circumferential surface therebetween;
a bushing having a bushing diameter and defining a bushing hole, said bushing diameter being smaller than the body hole diameter;
a plurality of positioners for securing the bushing within the body hole such that a position of the bushing within the body hole is adjustable, wherein said body defines a corresponding plurality of positioner passageways through said body from said outer circumferential surface to said inner circumferential surface, said passageways adapted to receive the positioners; and
a plurality of securing pins for securing the body to a fixture, wherein said body defines a plurality of securing holes through said first and second surfaces for receiving the securing pins.

9. An adjustable drill bushing alignment assembly as claimed in claim 7, wherein the plurality of securing holes are substantially equidistant spaced.

10. An adjustable drill bushing alignment assembly as claimed in claim 7,
wherein said plurality of positioners are threaded pins,
wherein the plurality of positioner passageways are threaded and are adapted to receive the corresponding plurality of threaded pins such that said plurality of threaded pins extend into the body hole.

11. An adjustable drill bushing alignment assembly as claimed in claim 7,
wherein said bushing has a bushing outer circumferential surface which defines a groove at least partially along the bushing outer circumferential surface;
and wherein an end of each of the plurality of positioners is adapted to fit within the groove.

12. An adjustable drill bushing alignment assembly as claimed in claim 7,
wherein a center of the body hole is offset from a center of the body.

13. An adjustable drill bushing alignment assembly as claimed in claim 7,
wherein a center of the bushing hole is offset from a center of the bushing.

14. An adjustable drill bushing alignment assembly as claimed in claim 7, wherein the body is adapted to receive any one of a variety of different diameter bushings.

15. A drill bushing alignment assembly, comprising:
a fixture;
a body defining a body hole having a body hole diameter and defining a plurality of substantially equidistant spaced securing holes,
a bushing defining a bushing hole therethrough, said bushing having a diameter smaller than said body hole diameter;
a plurality of positioners for securing the bushing within the body hole such that a position of the bushing within the bushing hole is adjustable;
a plurality of threaded screws and a corresponding plurality of threaded nuts, each of said plurality of threaded screws being adapted to receive one of the threaded nuts;
wherein said fixture defines a plurality of substantially equidistant openings,
wherein at least one of the substantially equidistant openings is a slot,
wherein said substantially equidistant spaced securing holes defined in the body correspond to the plurality of substantially equidistant openings defined in the fixture, and
wherein each of said corresponding securing holes and openings are adapted to receive a threaded screw for securing the body to the fixture.

16. A drill bushing alignment assembly as claimed in claim 13,
wherein said plurality of positioners are threaded pins,
wherein said body defines a plurality of threaded passageways therethrough adapted to receive the corresponding plurality of threaded pins such that said plurality of threaded pins extend into the body hole.

17. A drill bushing alignment assembly as claimed in claim 13,
wherein said bushing has a bushing outer circumferential surface which defines a groove at least partially along the bushing outer circumferential surface;
and wherein an end of each of the plurality of positioners is adapted to fit within the groove.

18. A drill bushing alignment assembly as claimed in claim 13,
wherein a center of the body hole is offset from a center of the body.

19. A drill bushing alignment assembly as claimed in claim 13,
wherein a center of the bushing hole is offset from a center of the bushing.

20. A drill bushing alignment assembly as claimed in claim 13,
wherein the body is adapted to receive any one of a variety of different diameter bushings.

21. A drill bushing alignment assembly comprising:
a body having a first surface and a second surface and an outer circumferential surface therebetween, said body defining a body hole having a body hole diameter through said first and second surfaces thereby forming an inner circumferential surface therebetween;
a bushing having a bushing diameter and defining a bushing hole, said bushing diameter being smaller than the body hole diameter;
three threaded positioners for securing the bushing within the body hole such that a position of the bushing within the body hole is adjustable, wherein said body defines three correspondingly threaded positioner passageways through said body, said threaded positioner passageways adapted to receive the positioners; and
a plurality of securing pins for securing the body to a fixture, wherein said body defines a plurality of substantially equidistant spaced securing holes through said first and second surfaces for receiving the securing pins.

22. A drill bushing alignment assembly as claimed in claim 19, wherein two of the substantially equidistant spaced securing holes are slots that allow rotation about the securing pins.

23. A method of repositioning a bushing from an initial position to a second position using an adjustable drill bushing alignment assembly secured to a fixture without disengaging the adjustable drill bushing alignment assembly from the fixture, said drill bushing alignment assembly having a body defining a body hole having a body hole diameter, a bushing defining a bushing hole therethrough, and a plurality of adjustable positioners for adjustably securing the bushing within the body hole, said method comprising the step of:
adjusting in an x-y plane the plurality of adjustable positioners securing said bushing in said body hole of the drill bushing alignment assembly such that said bushing is repositioned from said first position to said second position while being maintained within the body hole of the drill bushing alignment assembly.

24. A method of repositioning a bushing from an initial position to a second position using an adjustable drill bushing assembly secured to a fixture by a plurality of removable fasteners, received by a plurality of corresponding substantially equidistant openings in the fixture and the adjustable drill bushing assembly, wherein said adjustable drill bushing assembly comprises
a body defining a body hole having a body hole diameter,
a bushing defining a bushing hole therethrough, said bushing having a diameter smaller than said body hole diameter;
a plurality of positioners adjustably securing the bushing within the body hole, said method comprising the steps of:
removing the removable fasteners coupling said adjustable drill bushing assembly to said fixture;
rotating the adjustable drill bushing from the initial position to the second position; and
reinstalling the removable fasteners such that the adjustable drill bushing assembly is coupled to the fixture with the bushing in the second position.

25. A method according to claim 20, further comprising the step of:
adjusting the plurality of positioners securing the bushing within the body hole such that the bushing is repositioned relative to the body.
